(19) United States
(12) Patent Application Publication
(10) Pub. No.: US 2008/0181132 A1
(43) Pub. Date: Jul. 31, 2008

(54) Command Anywhere Mobile Mesh System

(75) Inventors: Jerry Underhill, Costa Mesa, CA (US); Robert Lloyd, Costa Mesa, CA (US)

Correspondence Address: PROCOPIO, CORY, HARGREAVES & SAVITCH LLP, 530 B STREET, SUITE 2100, SAN DIEGO, CA, 92101, US

(73) Assignee: LARGE SCREEN DISPLAY RENTALS, LLC., Santa Ana, CA (US)

(21) Appl. No.: 12/021,211

(22) Filed: Jan. 28, 2008

Related U.S. Application Data
(60) Provisional application No. 60/886,861, filed on Jan. 26, 2007.

(51) Int. Cl. H04B 7/00; H04L 12/28

(52) U.S. Cl. 370/254; 370/310

(57) ABSTRACT

CAMMS is a system of hardware and software to enable emergency responders to exchange information and communicate with each other in crisis-response situations. CAMMS creates a “Mesh” network on an ad-hoc basis, without user intervention, and allows all users on the mesh to engage in audio-video conferencing, telephone calls, exchange text messages, computer files of any type including images, movies and documents, as well as to discover and view IP Video Camera feeds, and to provide gateways to other networks and whiteboard conferencing. CAMMS is designed around industry standards for increased interoperability with other systems, and is configured to allow non-technical emergency response personnel to utilize all of its features.

### RELATED APPLICATION

The present application claims priority to U.S. provisional patent application Ser. No. 60/886,861 filed on 26 Jan. 2007, which is incorporated herein by reference in its entirety.

### BACKGROUND

1. Field of the Invention

The present invention is generally related to ad hoc mobile mesh networks and more particularly related to secure ad hoc networks established by responders to emergency situations that represent discrete crisis response agencies.

2. Related Art

First responder command centers suffer from the inability to effectively communicate between different agencies (e.g., police, fire, water, etc.) during the course of an event such as a fire or other event that involves an emergency response. Similarly, these agencies also experience difficulties communicating with each other due to power outages, cell tower interference, and other unexpected problems during dynamic events. Additionally, first and subsequent responders also suffer from a lack of information about the personnel that have responded to an event. Therefore, what is needed is a system and method that overcomes these significant problems found in the conventional systems as described above.

### SUMMARY

Described herein is a system and method that allows a “mesh” network to be established on an ad-hoc basis, between any two or more vehicles equipped with the command anywhere mobile mesh system (“CAMMS”) package. CAMMS is designed primarily for crisis-response agencies, allowing them to create a network among all the responders to an incident, without the need for any fixed infrastructure. Once this network has been created, CAMMS provides audio-video conferencing, telephone services, GPS enhanced mapping services, file-sharing, Instant Messaging, White-boarding, Internet access, and automatic detection and display of streaming IP camera feeds to all units in the mesh.

CAMMS comprises software modules that are deployed in combination with certain mesh networking hardware and mobile computing devices capable of executing the software modules. For example, a standard Windows notebook, a hand-held wireless communication device or tablet computer, just to name a few. The CAMMS software controls the networking hardware to establish a mesh network, and provides an easy-to-use interface to allow non-technical users to make full use of the capabilities of the software.

The network hardware used by CAMMS comprises Access Points (APs) for example, the Proxim AP-4900M that is a dual-radio unit, having both a 2.4 GHz 802.11b/g radio and a 4.9 or 5.0 GHz 802.11a radio. The 802.11a link (4.9 GHz for authorized users in the Public Safety sector, 5.0 GHz for private users) is used to carry network traffic, while the standard 2.4 GHz “Wi-Fi” connections are used primarily for communication between a specific AP and a remote device such as a hand-held wireless communication device, tablet PC, internet protocol (IP) camera, and the like. CAMMS can also be used with other network hardware, with dual-radio units being most advantageous.

The CAMMS software is the center of the CAMMS system. Widely-used protocols and standards such as HTML, XML and DHCP are used or supported. The software overcomes a particular weakness of standard AP hardware, which is the need for some units in the mesh network to be configured as “Portal” APs, while the majority of the units are configured in “AP” mode. Unfortunately, an AP in “Portal” mode cannot connect directly to another AP also in “Portal” mode; nor can an AP configured in “AP” mode connect to another AP also in “AP” mode, unless there is another AP in the mesh configured in “Portal” mode. CAMMS overcomes this limitation by monitoring and controlling the AP hardware.

Upon startup, CAMMS connects to the AP and queries it as to status, configured mode, and “meshed” neighbors (e.g., other APs connected to the local AP). If the connection with the AP is successfully established, but no other APs are “meshed” to the local AP, CAMMS re-configures the AP by toggling the configured mode of the AP, restarting the AP, and checking again for “meshed” neighbor APs. If no other AP is found during the time-out period (which is user-configurable), CAMMS repeats the process, until it finds a neighboring AP. Thus, the CAMMS software can be started at the beginning of a shift, and the software will automatically connect to any other AP that comes into range. If a CAMMS unit is configured as a “Portal”, and the unit must leave the scene of an incident, the CAMMS software can “nominate” a replacement Portal from among the other units in the mesh, and can “hand-off” the Portal status to this nominated unit when leaving the scene. CAMMS is designed such that there is no centralized server unit required—each CAMMS installation in each unit can provide what is needed to establish the network and to exchange information.

If a particular unit has wireless Internet access (through a cell phone, wireless networking card, or satellite link), this can be shared among all the users of the mesh. The same is true of other types of connectivity, such as access to web-based Emergency Operations Center Management software. CAMMS allows units equipped with such software to advertise the availability of this software to all units in the mesh.

CAMMS also offers benefits even in the absence of other “meshed” units. For instance, a Police Officer responding to a call can take his PDA, SmartPhone, or other portable wireless device into the house or building while he interviews the victim or witnesses. If the officer has suspect photos on the notebook in his car, these can be accessed from the PDA while the officer remains in the house. Also, if the PDA or SmartPhone is equipped with a camera, the officer can take a photo and send it back to the notebook in his car. If a mesh has been established, this image can be shared to the entire network.

Should an incident become large enough to require assistance from other agencies, any CAMMS-equipped units from the other agencies can join the mesh. Should the outside units not be equipped with CAMMS, any standard 802.11b/g Windows computer can be used when equipped with a version of the CAMMS software that does not control any hardware. This allows these units to participate in the mesh as long as the incident continues. This version of CAMMS will run on any standard Windows-based computer with an 802.11b or 802.11g Wi-Fi capability, which is now standard on most notebooks. CAMMS will also run on other hardware platforms as needed.

CAMMS can also provide information to any Wi-Fi device that has a web browser, allowing non-Windows machines (such as PDAs or Apple notebooks) to participate in the mesh. “CAMMS Web” allows the web-based download of images, movies, documents, or other files; the upload of files to the mesh; and Instant Messaging, all through the mesh network.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example incident responder according to an embodiment of the present invention;

FIG. 2 is a network diagram illustrating an example mesh network according to an embodiment of the present invention;

FIG. 3A is a network diagram illustrating an example mesh network according to an embodiment of the present invention;

FIG. 3B is a network diagram illustrating an example network 45 according to an alternative embodiment of the present invention;

FIG. 4 is a block diagram illustrating an example responder device connected to a mesh network according to an embodiment of the present invention;

FIG. 5 is a block diagram illustrating an example CAMMS module according to an embodiment of the present invention;

FIG. 6 is a flow diagram illustrating an example process for a responder device to join a mesh network according to an embodiment of the present invention;

FIG. 7 is a block diagram illustrating an example wireless communication device that may be used in connection with various embodiments described herein; and

FIG. 8 is a block diagram illustrating an example computer system that may be used in connection with various embodiments described herein.

### DETAILED DESCRIPTION

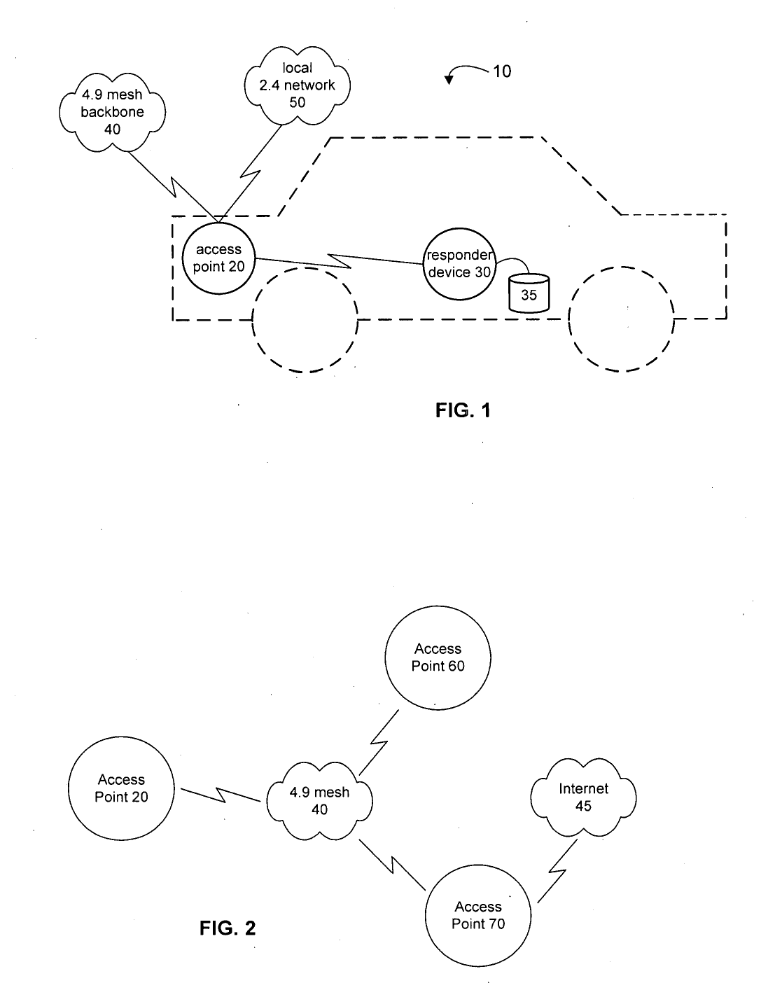

FIG. 1 is a block diagram illustrating an example incident responder 10 according to an embodiment of the present invention. In the illustrated embodiment the incident responder 10 is shown as a vehicle comprising a responder device 30 configured with a data storage area 35. The responder device 30 is communicatively coupled with an access point 20 that is equipped for wireless communication over a local 2.4 gigahertz wireless communication network 50 and also over a 4.9 gigahertz mesh network 40. In an alternative embodiment, the access point 20 may communicate over a single wireless communication network. In alternative embodiments, the incident responder 10 can be a police car, fire truck, ambulance, power company truck, water department vehicle, or a representative of any other public, quasi public, or private entity that responds to an incident, for example a fire.

The responder device 30 can be any of a variety of computing devices capable of executing software programs and capable of establishing communication either wired or wirelessly with the access point 20. For example, the responder device 30 may be directly connected to the access point via a wired link.

Access point 20 can be any of a variety of wireless network access points that are capable of facilitating data communication over a wireless physical medium. In one embodiment, the access point 20 is a Proxim AP-4900M that is a dual-radio unit, having both a 2.4 GHz 802.11b/g radio and a 4.9 or 5.0 GHz 802.11a radio. The 802.11a link (4.9 GHz for authorized users in the Public Safety sector, 5.0 GHz for private users) is used to carry mesh network traffic, while the standard 2.4 GHz “Wi-Fi” connections are used primarily for communication between the access point 20 and a remote device.

FIG. 2 is a network diagram illustrating an example mesh network 40 according to an embodiment of the present invention. In the illustrated embodiment, the mesh network 40 comprises wireless communications (e.g., over the 4.9 gigahertz band) between a plurality of access points 20, 60, and 70. Each of the access points are configured for wireless communications over the 4.9 mesh network 40. In one embodiment, an access point 70 is also communicatively coupled with a second network 45. For example, the access point 70 may be connected to the Internet 45 via a satellite radio or other wireless link. Advantageously, the access point 70 may advertise to the other access points that it has connectivity to the Internet 45 such that the other access points 20 and 60 can provide Internet access to any devices that are in communication with those access points, respectively.

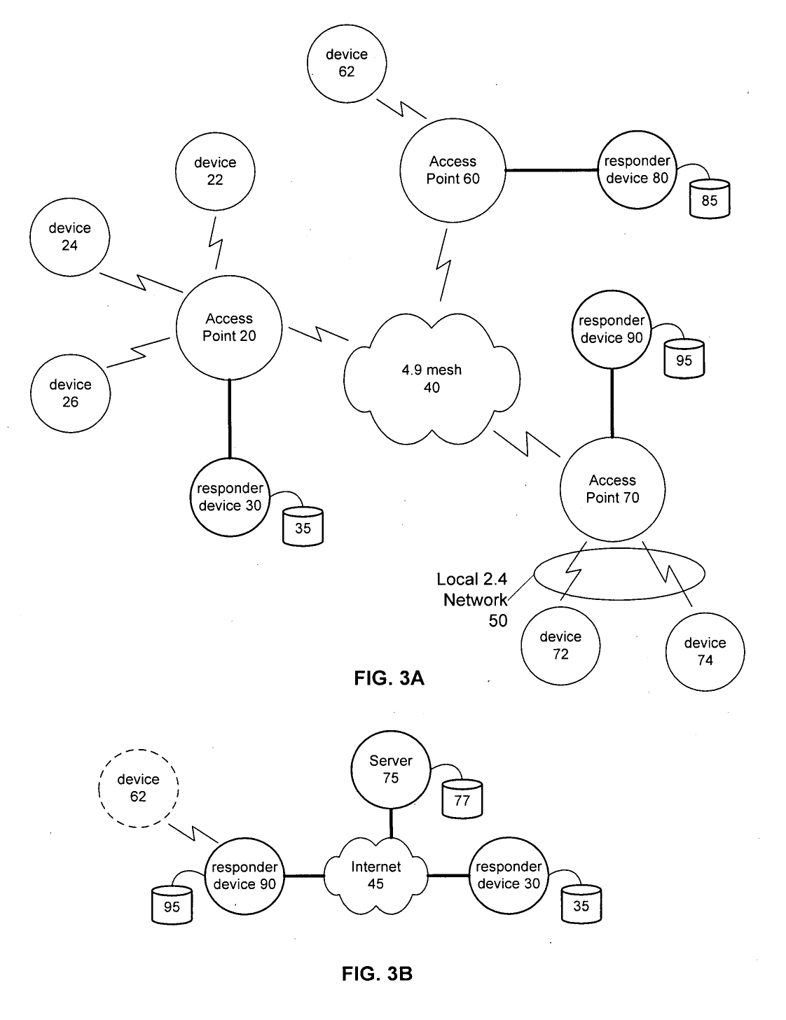

FIG. 3A is a network diagram illustrating an example mesh network 40 according to an embodiment of the present invention. In the illustrated embodiment, the mesh network 40 comprises access points 20, 60, and 70. Each of the access points 20, 60, and 70 are respectively connected to responder devices 30, 80, and 90. Each of the responder devices is configured with a data storage area 35, 85, and 95, respectively. The responder devices each have a CAMMS module stored in the data storage area that allows the responder device to send and receive data over the wireless mesh network 40 to facilitate communication between responder devices during an incident.

Additionally each access point 20, 60, and 80 may have one or more additional devices 22, 23, 26, 62, 72, and 74 that are in wireless communication with the access points, respectively. These communications take place over a local 2.4 gigahertz network in an embodiment where an access point has dual radio capabilities and can communicate on more than one frequency network. For example, device 22 may be a fixed position security camera, device 24 may be a smartphone, and device 26 may be a mobile helmet camera attached to a person.

FIG. 3B is a network diagram illustrating an example network 45 according to an alternative embodiment of the present invention. In the illustrated embodiment, the network 45 is the Internet, although it could be any variety of data communication network. In this embodiment, all the functionality available to the responder devices 30 and 90 remains available. The discovery of peer responder devices takes place via a server 75 (configured with a data storage area 77) that is connected to each responder device via the network 45. The server thus facilitates direct communication between the responder devices by performing initial responder device discovery and adding any new responder device to the community. The various responder devices in this type of embodiment can also have local devices they are in communication with such as device 62. Finally, this sort of embodiment can also be coupled with the embodiment described in FIG. 3A such that the overall system includes responder devices that are interconnected via a wireless mesh network and also via the Internet 45 or other network.

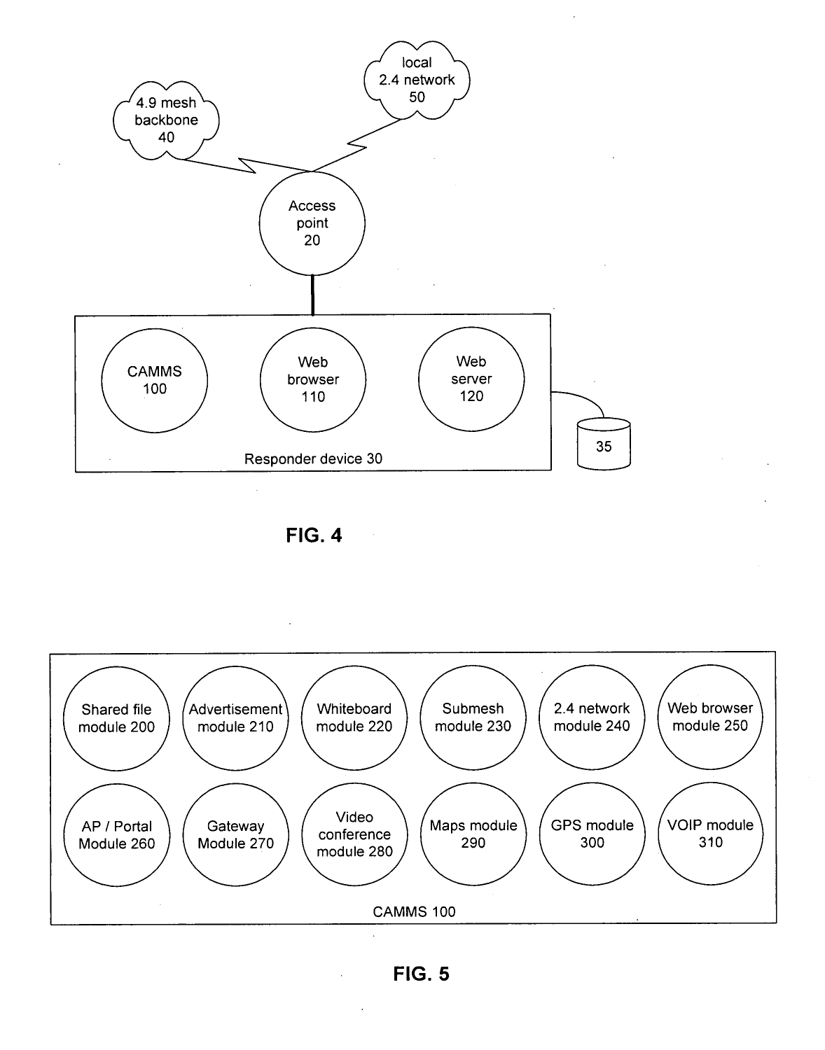

FIG. 4 is a block diagram illustrating an example responder device 30 connected to a mesh network 40 according to an embodiment of the present invention. In the illustrated embodiment, the responder device 30 comprises a CAMMS module 100, a web browser 110, and a web server 120. The responder device 30 is also configured with a data storage area 35.

The CAMMS module 100 is configured to control the access point 20 and cause the access point to join the mesh network 40 in access point (AP) mode or in portal mode. Just one AP in the mesh network 40 is in portal mode during operation. If no other access points are present when the CAMMS module 100 initially attempts to join the mesh network 40, the CAMMS module 100 toggles the access point 20 between AP mode and portal mode until a second access point is identified and one of the two access points is initialized in portal mode. After the first two access points have established the mesh network 40, additional access points are initialized by the CAMMS module and if necessary are toggled into AP mode so that they may also join the wireless mesh network 40. In this fashion, the CAMMS module 100 working in cooperation with other CAMMS modules on other responder devices is able to establish communications over the wireless mesh network 40.

The web browser 110 is a conventional web browser on the responder device 30 and is capable of sending queries to a web server (such as web server 120) using the HTTP protocol. The web browser 110 is also capable of displaying content to a user of the responder device 30. The web browser 110 may also launch application specific windows or other utilities to appropriately process application specific information.

The web server 120 is a conventional web server that is capable of responding to requests and serving up content. The web server 120 may be configured to host certain local files and information and provide such local files and information to network devices such as other responder devices (not shown). The web server 120 may perform this function under the control of the CAMMS module 100. For example, the CAMMS module 100 may instruct the web server 120 to host a particular file. Accordingly, the CAMMS module 100 may advertise to the other devices on the network that the file is present and available and when a remote device requests the file, the web server 120 responds to the request by providing the file to the requesting device. In this fashion, the CAMMS module 100 can control the resources that are available via the mesh network 40 while allowing other applications such as the web browser 110 and the web server 120 to carry out certain necessary functions such as serving up content and displaying content.

In one embodiment, the data storage area 35 can locally house all of the information that is part of a particular incident. The data storage area 35 can locally store just that information that was shared by the particular responder device 30 or it can obtain all of the information shared by any responder device so that it has a complete copy of all shared files, whiteboards, communications, and other information that was part of an incident. The data storage area 35 can also store information for multiple events.

Advantageously, when the responder device 30 returns to a central location, e.g., the police station, the responder device 30 can upload to a central storage area all of the information it has stored for a particular incident or for all incidents. Additionally, other responder devices (not shown) can also upload their locally stored information so that the central storage area includes all information from all responder devices. Furthermore, this collection of information can later be combined with information from other groups, e.g., fire, utilities, water, etc., so that a complete picture of all information related to a particular incident can be reviewed or archived.

FIG. 5 is a block diagram illustrating an example CAMMS module 100 according to an embodiment of the present invention. In the illustrated embodiment, the CAMMS module 100 comprises a shared file module 200, an advertisement module 210, a whiteboard module 220, a submesh module 230, a 2.4 network module 240, a web browser module 250, an AP/portal module 260, a gateway module 270, a video conference module 280, a maps module 290, a global positioning system (“GPS”) module 300, and a voice over internet protocol (“VOIP”) module 310.

The shared file module 200 is configured to identify local files on the responder device 30 and share those resources with other CAMMS modules that are in communication via the mesh network 40. For example, when a user desires to share a particular file with other users, the shared file module 200 identifies the shared resource and then advertises the availability of that resource to the other CAMMS modules on other responder devices. Similarly, the shared file module 200 receives advertisements from other CAMMS modules and maintains an appropriate list of resources that are available from other responder devices so that if a user requested such a shared resource the shared file module 200 would then request the shared resource from the responder device that advertised the availability of the resource.

The advertisement module 210 works in concert with other local modules and remote advertisement modules to inform users around the network of the availability of shared resources and other items.

The whiteboard module 220 is configured to allow multiple users across the wireless mesh network to implement a whiteboard communication session including overlays on image files, chat messaging, closed chat messaging, real time video feeds, and the like. Advantageously, the whiteboard module 220 is capable of providing sophisticated whiteboard functionality between the various CAMMS modules around the network.

Submesh module 230 is configured to allow certain members of the mesh network to form a secure subgroup for closed circuit communications. Such closed circuit communications may range from password protected shared files to submesh specific whiteboards that are only accessible by those responder devices that are configured as part of a particular submesh. For example, all responder devices from a particular public agency such as the fire department may establish a submesh amongst each other and employ a fire department only whiteboard to communicate fire department specific information amongst themselves. Similarly, the police may also for a submesh, for example.

The 2.4 network module 240 is configured to manage devices that are in communication with the local access point via the local 2.4 gigahertz wireless link. For example, hand held wireless communication devices, security cameras, and other local wireless devices. The 2.4 network module 240 may work in concert with the advertisement module 210 to inform other responder devices of the availability of information, e.g., a video stream from a security camera, from devices on the 2.4 gigahertz network.

The web browser module 250 is configured to launch a web browser or associated utility or application as needed in order to display or otherwise provide content or information to a user. The AP/portal module 260 is configured to toggle the access point between AP and portal mode as needed in order to get the access point to initiate or join the 4.9 mesh network as needed.

The gateway module 270 is configured to establish the responder device 30 as a gateway to a second network. For example, the second network may be the Internet and the gateway module 270 allows the CAMMS module 100 to inform other responder devices that traffic destined for the Internet should be routed through the particular CAMMS module 100. In one embodiment, the CAMMS module 100 is connected to the Internet via a satellite radio modem or a Wi-Fi wireless network.

The video conference module 280 is configured to establish an implement real time video conference sessions between responder devices. The video conference module 280 is also configured to provide an audio link as part of the video conference. Advantageously, each video conference session is maintained within a separate window on the responder device 30 and the user can selectively control the audio and video links to each other user in a session. Thus, an audio-video conference may be established between three users and the first user may turn off the audio link with the second user in order to have a private audio session with the third user. The same capability is provided for the video link. Thus, the video conference module 280 allows a user to selectively collaborate with any other individual user or group of users.

The maps module 290 is configured to provide location sensitive graphical map information to a single user and/or the entire mesh network. In one embodiment the maps module 290 initiates with a map of the United States or some other location that can be predetermined by the user. The map module 290 provides a “map mesh” functionality that when requested will show the current position of each member of the mesh network on the map. Advantageously, a user can select any member of the mesh, for example by putting the focus of the mouse on the desired member and then information about that member will be displayed. For example, the GPS coordinates, the distance to that mesh member, the resources available at that mesh member (e.g., firearms, hoses, people, etc.). In one embodiment, the resources available to a particular vehicle or mesh member may be tracked by radio frequency identification (“RFID”) tags or other such devices. This information is available to the map module 290 via the mesh network so that each user can dynamically see all of the resources that are available at a particular location within the scene of the event.

The GPS module 300 is configured to operate in connection with the maps module 290 and provide GPS location information. In one embodiment the GPS module interacts with an external stand alone GPS device that connects to a responder device 30, for example via a universal serial bus (“USB”) cable. The GPS module 300 provides the GPS location information to the maps module 290 for proper location of the various mesh members on the map.

The VOIP module 310 is configured to provide a private branch exchange (“PBX”) capability to the mesh network. This allows IP phones at any vehicle in the mesh network to place and receive telephone calls during an event as long as there is an available network connection, for example via a satellite. This is particularly advantageous when local cell towers are not operational and/or when radio interference makes communication between responders unreliable.

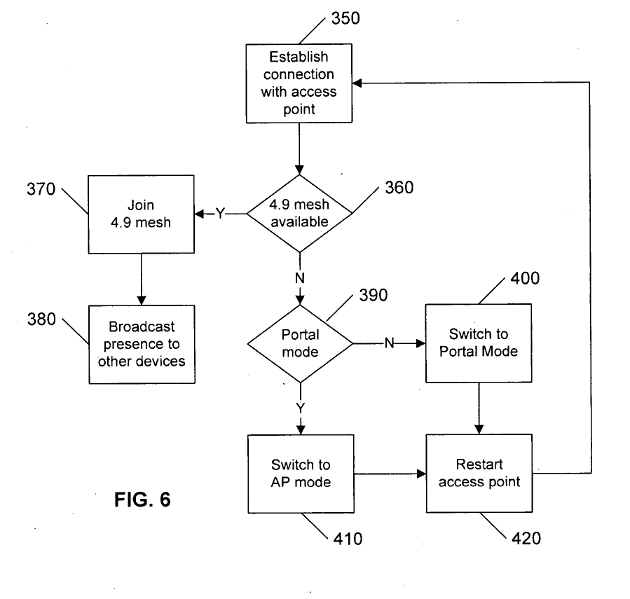

FIG. 6 is a flow diagram illustrating an example process for a responder device to join a mesh network according to an embodiment of the present invention. The illustrated process may be carried out by a responder device such as the one previously described with respect to FIG. 4. Initially, the responder device establishes a connection with the access point. At that time, the CAMMS module determines if a 4.9 gigahertz mesh network is available. If there is one that is available, the CAMMS module joins the mesh network and broadcasts its presence around the network. If no 4.9 network is available, the CAMMS module determines if the access point is in portal mode or AP. The CAMMS module next toggles from either portal mode to AP mode or from AP mode to portal mode, after which a restart or reset is performed on the access point to cause it to re-initialize the process for establishing communications. Once a mesh network is identified as available, the CAMMS system joins the mesh and broadcasts is presence to the other devices on the network.

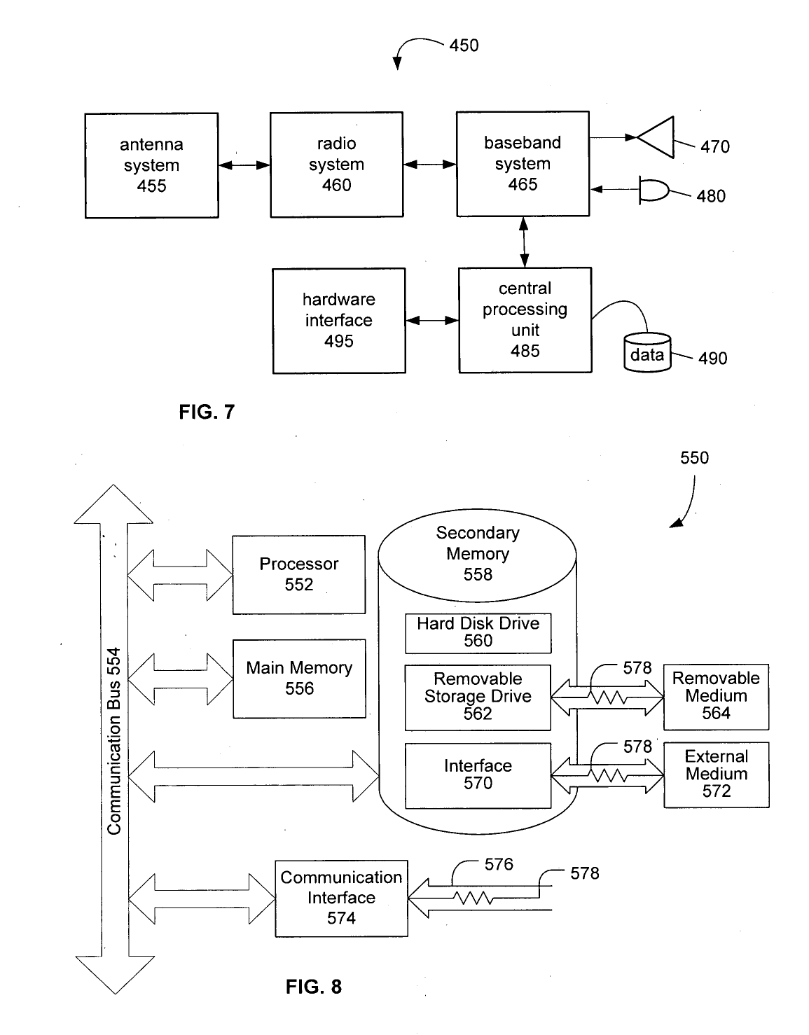

FIG. 7 is a block diagram illustrating an example wireless communication device 450 that may be used in connection with various embodiments described herein. Other wireless communication devices and/or architectures may also be used, as will be clear to those skilled in the art.

In the illustrated embodiment, wireless communication device 450 comprises an antenna system 455, a radio system 460, a baseband system 465, a speaker 464, a microphone 470, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIG. 5.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 8 is a block diagram illustrating an example computer system 550 that may be used in connection with various embodiments described herein. Other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for ad hoc mobile communications between first and subsequent responders to an event, the system comprising:
two or more access points configured for communication on a first wireless network at a first frequency and communication at a second frequency;
a wireless mesh backbone operating over the first wireless network, the wireless mesh backbone comprising the two or more access points, wherein the wireless mesh backbone employs the first frequency for wireless communications between the two or more access points;
one or more wireless mesh local communication networks, wherein each wireless mesh local communication network includes only one access point of the two or more access points and employs the second frequency for wireless communications between the access point and one or more wireless devices;
one or more responder devices, wherein each responder device is associated with only one access point and comprises:
a user interface;
a video conference module configured to enable audio-video communications between two or more responder devices;
a maps module configured to display a map on the user interface and identify the location of a responder device and display a graphic representing the responder device on the map; and
a shared file module configured to allow two or more responder devices to share information via the wireless mesh backbone.

2. A method for establishing a mobile mesh communication system for enabling communication between first and subsequent responders to the scene of an event, the method comprising:
establishing a communication link between a responder device and a first wireless communication access point capable of wireless communications on a first wireless network at a first frequency and a second wireless network at a second frequency;
searching for a second wireless communication access point capable of wireless communications on the first wireless network at the first frequency;
switching the first wireless communication access point from an access point mode to a portal mode when no second wireless communication access point is found;
repeating the searching and switching steps until a second wireless communication access point is found;
selecting the first wireless communication access point or the second wireless communication access point to operate in portal mode; and
establishing a wireless mesh backbone between the first and second wireless communication access points on the first wireless network at the first frequency.
